(19) United States
(12) Patent Application Publication
(10) Pub. No.: US 2026/0170488 A1
(43) Pub. Date: Jun. 18, 2026

(54) ENABLING OFF-LINE AUTHENTICATION AND/OR ACTIVITIES USING PAYMENT CARD DATA

(71) Applicants: American Express Travel Related Services Company, Inc., New York, NY (US); AMEX Canada, Inc, North York (CA); American Express Services Europe Limited, London (GB)

(72) Inventors: Ajay Babu Maddukuri, Phoenix, AZ (US); Magdalena McGoldrick, East York (CA); Manik Biswas, Burgess Hill (GB)

(21) Appl. No.: 18/982,415

(22) Filed: Dec. 16, 2024

(51) Int. Cl. G06Q 20/38; G06Q 20/34

(52) U.S. Cl. CPC G06Q 20/3821; G06Q 20/352; G06Q 20/3825; G06Q 20/3829

(57) ABSTRACT

Disclosed are various embodiments for allowing a user to use a client application while in offline mode to perform tasks that otherwise would require a network connection to a backend service associated with the client application. Card data including payment data and digital identifier data can be received from a physical card via a direct wireless connection. An authentication token can be generated in response to verifying card data. The authentication token can be used for the performance of a task that otherwise requires the device to be in an online mode.

### BACKGROUND

Applications that are executed on a client device (e.g., laptop, desktop, mobile phone, tablet, etc.) may need to interact with backend functionality for authentication prior to performing different tasks (e.g., transactions, access, identification, etc.). Backend authentication relates to the verification of one's identity on a server-side of an application and can provide a centralized and enhanced security. When an application is offline or otherwise is unable to connect to the backend for authentication, the application will be unable authenticate the user and therefore be unable to perform a given operation.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of an offline task environment according to various embodiments of the present disclosure.

FIG. 3 is a drawing of a networked environment according to various embodiments of the present disclosure.

FIG. 4 is a sequence diagram illustrating examples of functionality in the offline task environment of FIG. 2 according to various embodiments of the present disclosure.

FIG. 5 is a flowchart illustrating one example of functionality implemented as portions of an application executed in a client device in offline task environment and the network environment of FIG. 2 according to various embodiments of the present disclosure.

### DETAILED DESCRIPTION

Disclosed are various approaches for allowing a user to use a client application while in offline mode to perform tasks that otherwise would require a network connection to a backend service associated with the client application. In various examples, a user having a payment account associated with an issuer of a physical card may interact with a client-side issuer application to perform various tasks for the user associated with the payment account. The tasks can include initiating a transaction, gaining access to a location, verifying an identity, modifying one or more configurations within the issuer application, modifying user account data, and/or other types of tasks. Typically, the client side issuer application may need to interact with backend functionality for authentication in order for the client side issuer application to perform various tasks. According to various examples, when a client device is in an offline mode (e.g., lack of network connection), the user of the client device can use his or her physical card via a direct or direct wireless connection (e.g., near field communication (NFC), chip reader, Bluetooth, etc.) to “wake up” the corresponding client side issuer application. In particular, the payment data and digital identifier (ID) that is transmitted from the physical card to the client device can be used by the client side issuer application to authenticate the user and perform tasks in an offline mode that would otherwise require backend functionality.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

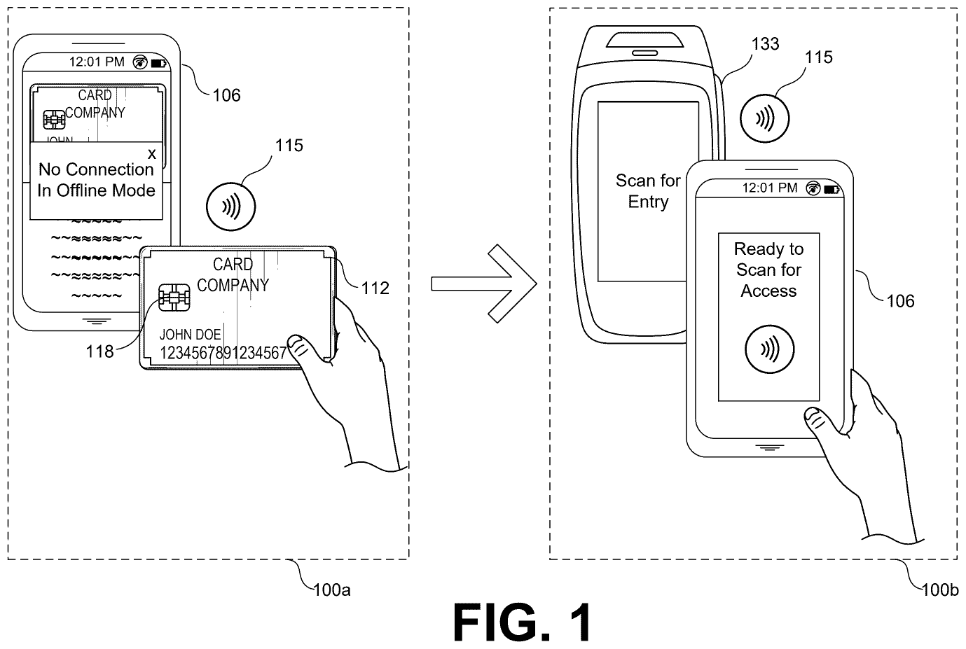

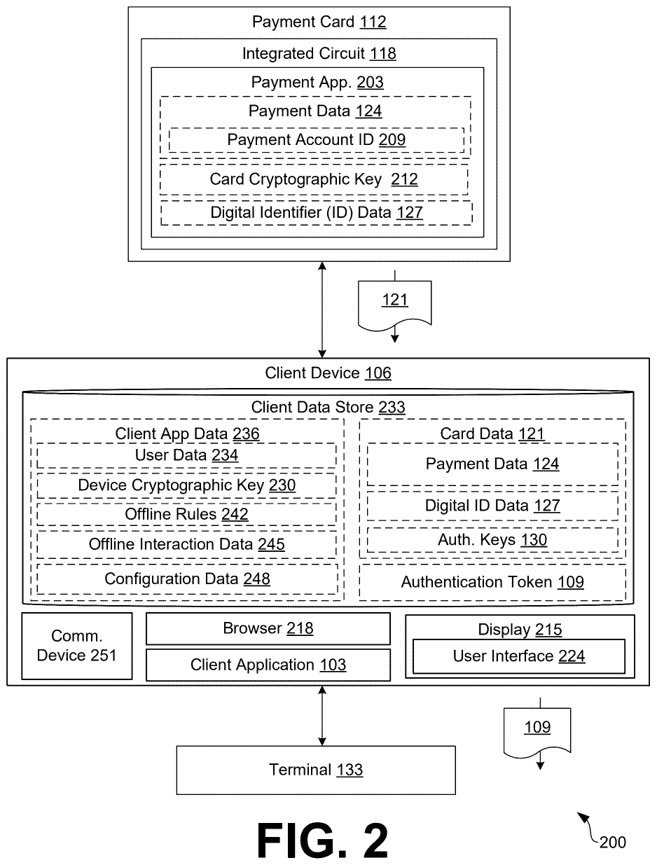

As illustrated in FIG. 1, shown is an example scenario 100 (e.g., 100a and 100b) in which a client application 103 (FIG. 2) executing on a client device 106 that is currently offline is able to operate and perform a task (e.g., generate and present an authentication token 109 (FIG. 2) for access to a location) that would otherwise require a backend authentication. Scenario 100a relates to a physical card 112 tapping or otherwise being placed in an appropriate proximity to the client device 106 to establish a direct wireless connection 115 (e.g., NFC, Bluetooth). Once the direct wireless connection is established, an integrated circuit 118 (e.g., a EUROPAY®, MASTERCARD®, and VISA® (EMV) chip with NFC capability or other type of short range wireless capability) on the physical card 112 can transmit card data 121 (FIG. 2) including payment data 124 (FIG. 2), digital identifier (ID) data 127 (FIG. 2), an authentication key(s) 130, and/or other data to the client device 106.

In various example, upon receiving the card data 121 from the direct wireless connection 115, the client application 103 associated with the payment account of the physical card 112 and executing on the client device 106 can obtain the card data 121 and use the card data 121 to generate an authentication token 109. The authentication token 109 can be used by the client application 103 in an offline mode to perform tasks that would otherwise require backend functionality. For example, the client application 103 can verify the card data 121 and use the authentication keys 130 included in the card data 121 to generate an authentication token 109. In various examples, the authentication key 130 can include time-based restrictions which in turn are used in generating an authentication token 109 with the same time-based restrictions.

As shown in scenario 100b, the client application 103 can instruct a user interacting with the client device 106 to present the authentication token 109 at a terminal 133. In the example of FIG. 1, the terminal 133 represents an access terminal, and the authentication token 109 is used by the user of the client device 106 to gain access to a given location. However, the terminal 133 can comprise a payment terminal, a point of sale (PoS) terminal and/or other type of terminal that accepts offline direct wireless communications (e.g., NFC, Bluetooth, etc.) for communicating with a client device 106 that is in an offline mode and provides a service to perform a given task. In various examples, once a direct wireless connection 115 is established between the terminal 133 and the client device 106 by tapping the client device 106 to the terminal 133 or otherwise placing the client device 106 within the appropriate proximate range to establish the short range connection, the authentication token 109 is transferred to the access terminal 133 via the direct wireless connection 115.

In the example of FIG. 1, the user is able to gain access to the location even when the client device 106 is in an offline mode because the card data 121 transmitted to the client device 106 through the direct wireless connection 115 can be used to generate the authentication token 109 needed for access to the given location. However, it should be noted that the card data 121 can be used by the client application 103 to perform various tasks in an offline mode that typically require backend authentication. The tasks can include initiating a purchase of an item, gaining access to a location, verifying an identity, modifying one or more configurations within the issuer application, updating user data and/or other types of tasks.

With reference to FIG. 2, shown is an offline task environment 200 for when a client device 106 is offline (e.g., lacking a network connection) and needing to perform a task that is typically performed when the client device is in an online mode (e.g., connected to a back-end computing environment via a network) according to various embodiments. The offline task environment 200 can include a payment card 112, a client device 106, and a terminal 133.

In various examples, the individual components can be communicatively coupled or otherwise in data communication with each other as depicted. In some instances, components can be directly or physically connected to each other (e.g., as when a payment card 112 is inserted into a terminal 133 to complete a transaction or when the client device 106 includes a card reader that can be used to read data generated from the payment card 112). In other examples, the payment card 112, the client device 106, and the terminal 133 can be in communication with each other via a wireless connection or personal area network (PAN). For example, the payment card 112 and the client device 106 could be configured to communicate with each other using near field communication (NFC), ultrawide band (UWB), Bluetooth®, or similar low energy, short range wireless communication mechanisms.

The payment card 112 can represent any smartcard usable for payments or other transactions. Accordingly, the payment card 112 can include an integrated circuit 118, which can comprise a chip or circuit that enables communication with a client device 106, a terminal 133, and/or other devices. The integrated circuit 118 can be a chip that complies with the Europay, Mastercard, and Visa (EMV) standard. The integrated circuit 118 can also be compliant with a different smart card or payment card standard. In some examples, the integrated circuit 102 can be placed onto the face of the payment card 112 such that one or more contacts associated with the integrated circuit 118 are exposed so that electrical contact can be made with chip readers or terminals 133 that are also implement EMV compliant. In various examples, the integrated circuit 118 can include direct wireless communication capabilities such as, for example, near-field communication (NFC), radio frequency identification (RFID), Bluetooth, and/or other direct wireless communication standards.

The integrated circuit 118 can be included in a payment card (e.g., a debit card, credit card, charge card, etc.) 112 to provide cryptographic authentication and verification of transactions (e.g., purchases) made using the payment card 112. For example, the integrated circuit 118 included in a payment card 112 could be used to authenticate a transaction to prove that the payment card 112 is an authorized or valid payment card 112 and has neither expired nor been counterfeited. Accordingly, an integrated circuit 118 can contain a payment application 203 as well as other data.

The payment application 203 can be provisioned on the integrated circuit 118 by an issuer (e.g., financial institution). The payment application 203 can be executed to confirm or authorize a transaction made by the payment card 112. In various examples, the payment application 203 can be executed to interact with a client application 103 provisioned by the issuer in association with the payment account issued by the issuer to provide authentication and verification to allow the client application 103 to operate when in an offline mode. The payment application 203 can include payment data 124, digital identifier (ID) data 127, a cryptographic key 212, and/or other data for a payment account associated with the payment card that contains the integrated circuit 118.

The payment data 124 can represent information associated with a payment account (e.g., bank account, credit account, etc.) that can be used to fund payments made with the payment card 112 using the payment application 203. This can include a payment account identifier 209, an expiration date, card issuer information, security credentials, and/or other data.

The payment account identifier 209 can represent any unique identifier that can uniquely identify a payment account with respect to another payment account. Examples of payment account identifiers 209 include bank account numbers (e.g., checking account or savings account numbers), credit card numbers, etc. In various embodiments of the present disclosure, the payment account identifier 209 could represent the actual payment account identifier 209 of an individual (e.g., his or her credit card number). In other embodiments, the payment account identifier 209 stored within a payment application 203 could be a payment token or virtual account identifier for the actual payment account identifier (e.g., a 16-digit number that acts as an alias for the actual 16-digit number that identifiers a user's credit card account).

The card cryptographic key 212 can represent any cryptographic key that can be used for the purpose of generating a cryptogram or digital signature used to authorize a transaction. In various examples, the card cryptographic key 212 is derived from an issuer master key (IMK) associated with the issuer and is provided upon provisioning of the payment application 203 by the issuer. In some examples, the card cryptographic key 212 is used by the payment application 203 to generate a cryptogram. In some examples, the card cryptographic key 212 comprises a private key that can be used to digitally sign card data 121 or payment data 124 that is transmitted from the payment card 112 to the client device 106. The card cryptographic key 212 is a unique cryptographic key that is unique to the given user and/or payment account.

The digital ID data 127 can comprise an electronic a digital certificate, a verifiable credential, a trust anchor, a proof of trust, and/or other type of data that can be used to verify the authenticity of the payment card 112. In various examples, the digital ID data 127 can be issued by a trusted certificate authority to uniquely identify the issuer of the payment card 112.

The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 215, such as liquid crystal displays (LCDs), gas plasma-based flat panel displays, organic light emitting diode (OLED) displays, electrophoretic ink (“E-ink”) displays, projectors, or other types of display devices. In some instances, the display 215 can be a component of the client device 106 or can be connected to the client device 106 through a wired or wireless connection.

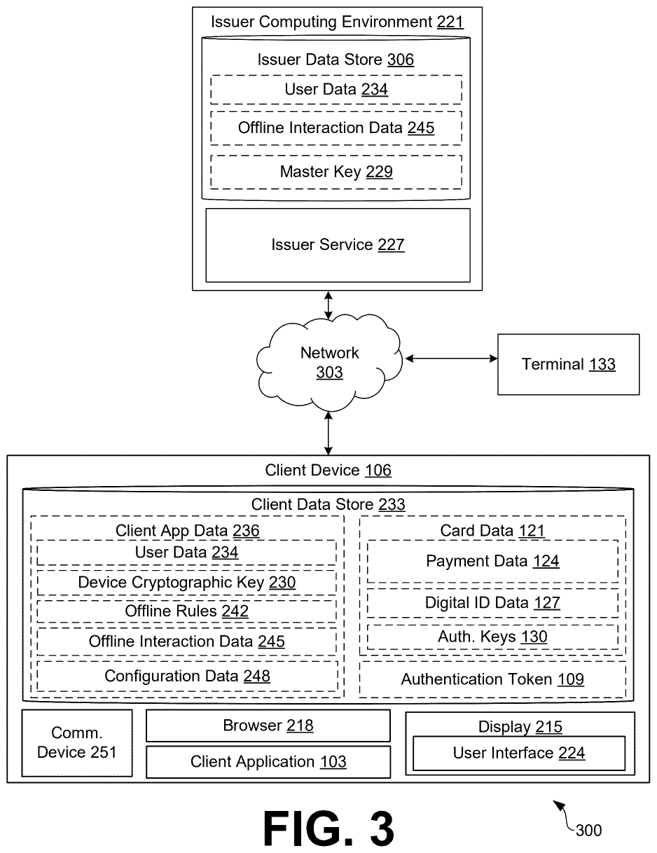

The client device 106 can be configured to execute various applications such as a browser 218, a client application 103 or other applications. The browser 218 can be executed in a client device 106 to access network content served up by the issuer computing environment 221 (FIG. 3) or other servers, thereby rendering a user interface 224 on the display 215. The client application 103 can comprise, for example, a dedicated application, etc., and the user interface 224 can comprise an application screen, etc. For example, the client application 103 can comprise a client application for the issuer of the payment card 112. The client device 106 can be configured to execute applications beyond the browser 218 and the client application 103 such as, for example, email applications, social networking applications, word processors, spreadsheets, and/or other applications.

The client application 103 can be executed to allow a user to manage his or her payment account associated with an issuer. In various examples, the client application 103 can be executed to allow the user to view payment account details, manage transactions, initiate transactions, modify account configurations (e.g., setting spending limits), modify user data (e.g., contact information, billing address, etc.), access locations, and/or other tasks associated with a payment account and/or the issuer of the issuer service. In various examples, as discussed in FIG. 3, the client application 103 can interact with an issuer service 227 (FIG. 3) associated with the issuer. The issuer service 227 can interact with the client application 103 to provide security services (e.g., authorization and authentication services needed by the client application 103 to perform various tasks), provide data synchronization across multiple devices and platforms, and/or other operations.

In various examples, when the client application 103 is in an offline mode and, therefore, unable to interact with the issuer service 227, the client application 103 can obtain card data 121 from a payment card 112 associated with the issuer to perform tasks that would otherwise be performed by the issuer service 227. In various examples, the card data 121 can include payment data 124, digital ID data 127, one or more authentication keys 130, and/or other data. In various examples, the client application 103 can validate the card data 121 to verify the authenticity of the payment card 112 providing the data as well as the payment account associated with the payment card 112.

In some examples, the payment data 112 can include a cryptogram that is generated by the integrated circuit 118 of the payment card 112. The cryptogram can be generated using a card cryptographic key 212 stored on the integrated circuit 118 and derived by a master key 229 (FIG. 3) held by the issuer in the issuer computing environment 221. Similarly, when the client application 103 is provisioned by the issuer, the client device 106 can obtain a device cryptographic key 230 that is stored in the client data store 233 and derived by the master key 229 held by the issuer. Accordingly, the device cryptographic key 230 and the card cryptographic key 212 can be unique to a given user and/or payment account.

In various examples, the client application 103 can generate another cryptogram using the user data 234 stored in the client device store 233 and the device cryptographic key 230. Since the device cryptographic key 230 and the card cryptographic key 212 are derived from the same master key 229 and the user data 234 and payment data 124 should match by being associated with the same payment account, the cryptogram included in the payment data 124 received from the payment card 112 and the cryptogram generated by the client application 103 should match. The client application 103 can validate the card data 121 by comparing the cryptograms to determine a match. When the cryptograms match, the client application 103 can validate the card data 121 and generating one or more authentication tokens 109 to perform tasks that would otherwise require the issuer service 227. The tasks can include initiating a purchase of an item, gaining access to a location, verifying an identity, modifying one or more configurations within the client application 103, and/or other types of tasks.

In some examples, the card data 121 can include a digital signature that is signed the card cryptographic key 212 and/or other key. For example, the payment data 124 can include a digital signature. In this example, the client application 103 can validate the card data 121 by verifying the digital signature.

In some examples, the client application 103 can verify the authenticity of the payment card 112 providing the card data 121. For example, the digital ID data 127 can include an electronic a digital certificate, a verifiable credential, a trust anchor, a proof of trust, and/or other type of data that can be used to verify the authenticity of the payment card 112. In various examples, the digital ID data 127 can be issued by a trusted certificate authority to uniquely identify the issuer of the payment card 112. The client application 103 can verify the authenticity of the payment card 112 based at least in part on using a public key associated with the trusted entity issuing the digital ID data 127.

Also, various data is stored in the client data store 233 that is accessible to the client device 106. The client data store 233 can be representative of a plurality of data stores as can be appreciated. The data stored in the client data store 233, for example, is associated with the operation of various applications and/or functional entities described herein. The client data store 233 can store client application data 236, card data 121 received from the payment card 112, an authentication token 109 generated by the client application 103 or the issuer service 227, and other data as can be appreciated.

The client application data 236 can include data associated with the client application 103. For example, the client application 236 can include user data 234, device cryptographic key 230, offline rules 242, offline interaction data 245, configuration data 248, and/or other data. The user data 239 corresponds to information related to individuals who have been issued payment accounts by the issuer who provisioned the client application 103. A payment account can represent any financial account or agreement that a customer can use as a source of funds for payments. Examples of payment accounts include charge or charge card accounts, credit or credit card accounts, checking accounts, savings accounts, money market accounts, demand accounts, deposit accounts, demand deposit accounts, etc.

The user data 234 can include payment instrument data, transaction history data, account address(es), account holder name, account holder contact information, authentication information, and/or other data associated with a user or user account provided by the issuer. The payment instrument data can correspond to data associated with payment accounts provided by the issuer. For example, the payment instrument data can comprise data describing credit card accounts, debit card accounts, virtual cards, charge card accounts, and/or other mechanisms for effecting a payment with respect to a transaction account provided by the issuer and associated with the user of the client device 106. For example, for a credit card account or a charge card account, the payment instrument data can store a card number, a cardholder name, an expiration date, a verification code, a billing address, and/or other information needed to consummate a payment.

The device cryptographic key 230 can represent any cryptographic key that can be used for the purpose of generating a cryptogram or digital signature. In various examples, the device cryptographic key 230 is derived from an issuer master key (IMK) associated with the issuer and is provided upon provisioning of the client application 103 by the issuer. In some examples, the device cryptographic key 230 is used by the client application 103 to generate a cryptogram. In some examples, the device cryptographic key 230 comprises a private key that can be used to digitally transaction data when initiating a transaction with a terminal 133 or merchant device. The device cryptographic key 230 is a unique cryptographic key that is unique to the given user and/or payment account.

The offline rules 242 include rules, models, and/or configuration data for the various algorithms or approaches employed by the client application 103 for operating in an offline mode. In addition, the offline rules 242 can include rules and/or configuration data defining what types of operations or tasks require the client application 103 to be in an online mode and/or what types of operations or tasks that require an online mode can be overridden by receiving and validating card data 121 from a payment card 112. For example, when the client application 103 is operating in an offline mode, the client application 103 is typically restricted from performing various tasks, such as, authentication, initiating a transaction, permitting access to a location, updating configuration data 248, updating user data 234 (e.g., billing address, contact information, etc.) and/or other tasks. However, in accordance with various examples of the present disclosure, a payment card 112 can be used to provide card data 121 that can be used by the client application 103 to generate authentication tokens 109 for performing the tasks that would otherwise be generated by the issuer service 227 when the client device 106 is in an online mode. The offline rules 242 can be used by the client application 103 to define how the client application 103 can operation to validate the card data 121 and generate authentication tokens 109 to perform tasks when the client application 103 is offline.

The offline interaction data 245 can represent data that is collected by the client application 103 in association to tasks completed offline. For example, the client application 103 can track the operations that it performs in an offline mode and then log data associated with the operations in the offline interaction data 245. The offline interaction data 245 can include data related to generating authentication tokens 109, initiating and completing a transaction, updating configuration data 248, updating user data 234, and/or any other task that the client application 103 can perform while in offline mode.

In some examples, the client application 103 can secure the offline interaction data 245 by digitally signing each recorded offline operation and store the signed operation in the offline interaction data 245. In some examples, the recorded operations can be digitally signed by the client application 103 using the device cryptographic key 230 or other cryptographic key that can be used to verify the authenticity of the client application 103. In some examples, the client application 103 can register each performed offline operation as a verifiable credential (VC). As such, when the issuer service 227 receives the offline interaction data 245, the issuer service 227 can contact a distributed ledger or other type of trusted entity to verify each verifiable credential to verify that the operations have occurred.

The configuration data 248 can represent settings for how the client application 103 is to function when executed on the client device 106. In various examples, the configuration data 248 is used to control the behavior of the client application 103. The configuration data 248 can be user defined, issuer defined, or a combination of both user defined and issuer defined.

The card data 121 can represent data received from the payment card 112 via a direct wireless connection 115 (e.g., NFC connection). In various examples, the card data 121 include payment data 124, digital identifier (ID) data 127, one or more authentication key(s) 130, and/or other data. The payment data 124 can represent information associated with a payment account (e.g., bank account, credit account, etc.) that can be used to fund payments made with the payment card 112 using the payment application 203. This can include a payment account identifier 209, an expiration data, card issuer information, security credentials, and/or other data. The digital ID data 127 can comprise an electronic a digital certificate, a verifiable credential, a trust anchor, a proof of trust, and/or other type of data that can be used to verify the authenticity of the payment card 112. In various examples, the digital ID data 127 can be issued by a trusted certificate authority to uniquely identify the issuer of the payment card 112. The one or more authentication keys 130 can include keys with time-based restrictions which in turn are used in generating an authentication token 109 with the same time-based restrictions. In various examples, the client application 103 use the authentication keys 130 included in the card data 121 to generate an authentication token 109 based at least in part on the time-based restrictions or other data, while in an offline mode.

The authentication token 109 can include a token that can be used to represent authorization of a user or user account associated with the client application 103 to perform a particular task. The tasks can include initiating a transaction, gaining access to a location, verifying an identity, modifying one or more configurations within the issuer application, modifying user account data, and/or other types of tasks. For security purposes, the authentication token 109 often has a time-limit associated with it, such as one hour, three hours, six hours, eight hours, or some other period of time. Once the time-limit has expired, the authentication token 109 can no longer be used to prove current authentication status of the user account. In some examples, the time-limit and other restrictions associated with the authentication token 109 are defined in authentication keys 130 included in the card data 121. In some examples, the authentication token 109 is generated by the client application 103 in response to verifying the card data 121 received from the payment card 112. In other examples, the authentication token 109 is generated by the payment card 112 and included in the card data 121. In the latter case, the client application 103 can verify the authentication token 109 prior to presenting the authentication token 109 for the completion of a task.

In various examples, the client device 106 can include a communication device 251 which can either be integrated within the client device 106 and/or in data communication with the client device 106. The communication device 251 can include a device that uses protocol standards to establish a direct wireless connection 115 with other devices with similar or like capability. For example, the communication device 251 can comprise an NFC device that uses NFC protocols to establish NFC peer-to-peer connections for exchanging data wirelessly via an NFC protocol to another devices with similar or like capability. In this example, the communication device 251 can include an NFC reader that allows the communication device 251 to obtain data being transferred from another NFC enabled device, such as, for example, the payment card 112.

The terminal 133 can represent a transaction system that can include a corresponding computer system or computing device with a processor and a memory. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), a payment terminal, an access terminal, a point of sale (PoS) system, or other devices with like capability.

In various examples, the terminal 133 can accept offline direct wireless communications (e.g., NFC, Bluetooth, etc.) for communicating with a client device 106 that is in an offline mode. For example, when a user is wanting to access a given location, the user could tap or otherwise place the client device 106 and/or communication device 251 of the client device 106 in an appropriate proximity to the terminal 133 to establish an offline direct wireless connection 115 with the terminal 133. Upon establishing a direct wireless connection 115, the client device 106 can transmit an authentication token 109 and other relevant data (e.g., payment data 124) to the terminal 133 providing a task associated service. In the example of an access terminal 133, the client application 103 via the communication device 251 can transmit the generated authentication token 109 to the terminal 133 which can then be used to permit the user associated with the client device 106 access into a given location. Similarly, in the example of a payment terminal 133, the client application 103 can initiate a transaction and generate transaction data with the authentication token 109 and transmit the transaction data and authentication token 109 to the terminal 133 to initiate a transaction.

With reference to FIG. 3, shown is a network environment 300 according to various embodiments. The network environment 300 can include an issuer computing environment 221, a client device 106, and a terminal 133, which can be in data communication with each other via a network 303.

The network 303 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 303 can also include a combination of two or more networks 303. Examples of networks 303 can include the Internet, intranets, extranets, virtual private networks (VPNs), and similar networks.

The computing environment 221 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 221 can employ a plurality of computing devices that can be arranged in one or more server banks or computer banks or other arrangements. Such computing devices can be located in a single installation or can be distributed among many different geographical locations. For example, the computing environment 221 can include a plurality of computing devices that together can include a hosted computing resource, a grid computing resource or any other distributed computing arrangement. In some cases, the computing environment 221 can correspond to an elastic computing resource where the allotted capacity of processing, network, storage, or other computing-related resources can vary over time.

Various applications or other functionality can be executed in the computing environment 221. The components executed on the computing environment 221 include an issuer service 227, and other applications, services, processes, systems, engines, or functionality not discussed in detail herein.

The issuer service 227 can interact with a client application 103 on a client device 106 to provide backend functionality for the client application 103. For example, the issuer service 227 can interact with the client application 103 to provide security services (e.g., authorization and authentication services needed by the client application 103 to perform various tasks), provide data synchronization across multiple devices and platforms, and/or other operations. In various examples, the issuer service 227 can receive offline interaction data 245 that is generated by the client application 103 when the client application 103 offline and, therefore, not connected to the issuer computing environment 221 via the network 303. The issuer service 227 can verify the offline interaction data 245 using one or more verification algorithms to verify that the offline interaction data 245 received is from an associated client application 103 and therefore, can be trusted. The issuer service 227 can use the offline interaction data 245 to update the user data 234 stored in the issuer data store 306 which will allow the issuer service 227 to provide data synchronization across multiple devices and platforms.

In some examples, the issuer service 227 can be executed to provision terminals 133 to accept payments using payment instruments issued by the issuer service 227. The issuer service 227 can receive pending transaction data with an authorization request for a given transaction from the terminal 133. Using the pending transaction data included in an authorization request, the issuer service 227 can confirm that funds or credit is available for a given payment instrument, such that the payment transaction is authorized to proceed or not authorized to proceed.

Also, various data is stored in the issuer data store 306 that is accessible to the issuer computing environment 221. The issuer data store 306 can be representative of a plurality of data stores 306, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the issuer data store 306 is associated with the operation of the various applications or functional entities described below. This data can include user data 234, offline interaction data 245, a master key 229, and potentially other data.

The user data 234 can include payment instrument data, transaction history data, account address(es), account holder name, account holder contact information, authentication information, and/or other data associated with a user or user account provided by the issuer. The payment instrument data can correspond to data associated with payment accounts provided by the issuer. For example, the payment instrument data can comprise data describing credit card accounts, debit card accounts, virtual cards, charge card accounts, and/or other mechanisms for effecting a payment with respect to a transaction account provided by the issuer and associated with the user of the client device 106. For example, for a credit card account or a charge card account, the payment instrument data can store a card number, a cardholder name, an expiration date, a verification code, a billing address, and/or other information needed to consummate a payment.

The offline interaction data 245 can represent data that is collected by the client application 103 in association to tasks completed offline and transmitted to the issuer computing environment 221 when the client device 106 is reconnected to the issuer computing environment 221 via the network 303 after being in an offline mode. For example, the client application 103 can track the operations that it performs in an offline mode and then log data associated with the operations in the offline interaction data 245. The offline interaction data 245 can include data related to generating authentication tokens 109, initiating and completing a transaction, updating configuration data 248, updating user data 234, and/or any other task that the client application 103 may perform while in offline mode. The issuer service 227 can verify the offline interaction data 245 and update the user data 234 and/or other data to ensure data synchronization across multiple devices and/or platforms.

The master key 229 can represent a cryptographic symmetric key that can be used to derive subordinate keys (e.g., session keys). In some examples, the master key 229 is unique to a given user and/or user account. The issuer service 227 can use the master key 229 to derive the device cryptographic key 230 when provisioning the client application 103 on the client device 106. Likewise, the issuer service 227 can use the master key 229 to derive the card cryptographic key 212 when provisioning the payment application 203 for a payment card 112 issued by the issuer for the payment account.

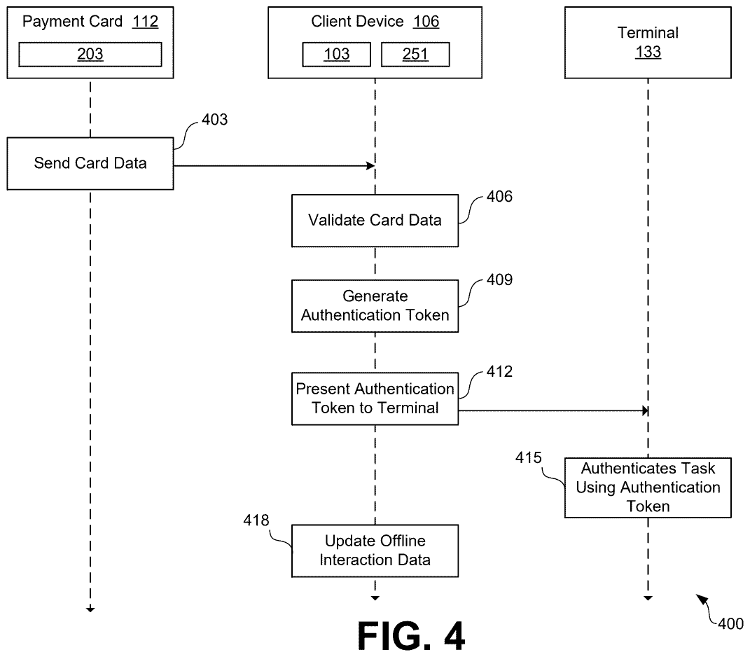

Referring next to FIG. 4, shown is a sequence diagram 400 depicting the interactions between the various components of the offline task environment 200 according to various embodiments of the present disclosure. The sequence diagram of FIG. 4 is intended to illustrate how the payment card 112 can be used to permit a client application 103 to perform tasks in an offline mode that would otherwise require the client application 103 to be in an online mode connected to an issuer service 227. As an alternative, the sequence diagram 400 of FIG. 4 can be viewed as depicting an example of elements of a method implemented within the offline task environment 200.

Beginning with block 403, the payment application 203 of a payment card 112 can send card data 121 to a client device 106. For example, a user of a payment card 112 can tap or otherwise position the payment card 112 in an appropriate proximity to the communication device 251 of the client device 106 to establish a direct wireless connection 115. Upon establishing a direct wireless connection 115, the payment application 203 can prepare and send card data 121 to the client device 106 for use by the client application 103 that is provisioned by the issuer of the payment card 112 and associated with the payment account of the payment card 112.

In various examples, the card data 121 can include payment data 124, digital ID data 127, one or more authentication keys 130, and/or other data. In some examples, the payment data 112 can include a cryptogram that is generated by the integrated circuit 118 of the payment card 112. The cryptogram can be generated using a card cryptographic key 212 stored on the integrated circuit 118 and derived by a master key 229 (FIG. 3) held by the issuer in the issuer computing environment 221.

At block 406, the client application 103 can validate the card data 121. In various examples, the client application 103 can generate another cryptogram using the user data 234 stored in the client device store 233 and the device cryptographic key 230. Since the device cryptographic key 230 and the card cryptographic key 212 are derived from the same master key 229 and the user data 234 and payment data 124 should match by being associated with the same payment account, the cryptogram included in the payment data 124 received from the payment card 112 and the cryptogram generated by the client application 103 should match. The client application 103 can validate the card data 121 by comparing the cryptograms to determine a match. When the cryptograms match, the client application 103 can validate the card data 121.

In some examples, the card data 121 can include a digital signature that is signed the card cryptographic key 212 and/or other key. For example, the payment data 124 can include a digital signature. In this example, the client application 103 can validate the card data 121 by verifying the digital signature.

In some examples, the client application 103 can verify the authenticity of the payment card 112 providing the card data 121. For example, the digital ID data 127 can include an electronic a digital certificate, a verifiable credential, a trust anchor, a proof of trust, and/or other type of data that can be used to verify the authenticity of the payment card 112. In various examples, the digital ID data 127 can be issued by a trusted certificate authority to uniquely identify the issuer of the payment card 112. The client application 103 can verify the authenticity of the payment card 112 based at least in part on using a public key associated with the trusted entity issuing the digital ID data 127.

At block 409, the client application 103 can generate an authentication token 109. The authentication token 109 can include a token that can be used to represent authorization of a user or user account associated with the client application 103 to perform a particular task. The tasks can include initiating a transaction, gaining access to a location, verifying an identity, modifying one or more configurations within the issuer application, modifying user account data, and/or other types of tasks. In some examples, the authentication token 109 can be generated to have a time-limit. Once the time-limit has expired, the authentication token 109 can no longer be used to prove current authentication status of the user account. In some examples, the time-limit and other restrictions associated with the authentication token 109 are defined in authentication keys 130 included in the card data 121.

It should be noted that although FIG. 4 shows the authentication token 109 being generated by the client application 103 in response to validating the card data, in some examples, the authentication token can be generated by the payment card 112 and included in the card data 121. In this situation, the client application 103 can verify the authentication token 109 when validating the card data 121 to ensure authenticity prior to presenting or otherwise using the authentication token 109 for the completion of a task.

At block 412, the client device 106 can be used to present the authentication token 109 to a terminal. In various examples, the client application 103 of the client device 106 can instruct a user interacting with the client device 106 to present the authentication token 109 at a terminal 133. In various examples, once a direct wireless connection 115 is established between the terminal 133 and the client device 106 by tapping the client device 106 to the terminal 133 or otherwise placing the client device 106 within the appropriate proximate range to establish the short range connection, the authentication token 109 can be transferred to the terminal 133 via the direct wireless connection 115 to thereby perform a given task. The task can include initiating a purchase of an item, gaining access to a location, verifying an identity, and/or other types of tasks.

At block 415, the terminal 133 can authenticate the performance of the task based at least in part on verifying the authentication token 109. For example, the terminal 133 can verify the authentication token 109 based at least in part on verifying a digital signature of the authentication token 109 and/or verifying any restrictions associated with the authentication token 109 (e.g., time-limits, etc.). In the example of an access terminal 133, once the terminal 133 verifies the authentication token 109, the user will be able to gain access into the location. In the example of a payment terminal 133, the terminal 133 can receive transaction details along with the authentication token 109. Accordingly, upon validation of the authentication token 109, the terminal 133 can interact with the issuer service 227 associated with the issuer to complete the transaction.

At block 418, the client application 103 can update the offline interaction data 245. The offline interaction data 245 can represent data that is collected by the client application 103 in association to tasks completed offline. For example, the client application 103 can track the operations that it performs in an offline mode and then log data associated with the operations in the offline interaction data 245. The offline interaction data 245 can include data related to generating authentication tokens 109, initiating and completing a transaction, and/or any other task that the client application 103 may perform while in offline mode.

In some examples, the client application 103 can secure the offline interaction data 245 by digitally signing each recorded offline operation and store the signed operation in the offline interaction data 245. In some examples, the recorded operations can be digitally signed by the client application 103 using the device cryptographic key 230 or other cryptographic key that can be used to verify the authenticity of the client application 103. In some examples, the client application 103 can register each performed offline operation as a verifiable credential (VC). As such, when the issuer service 227 receives the offline interaction data 245, the issuer service 227 can contact a distributed ledger or other type of trusted entity to verify each verifiable credential to verify that the operations have occurred. Thereafter, this portion of the process proceeds to completion.

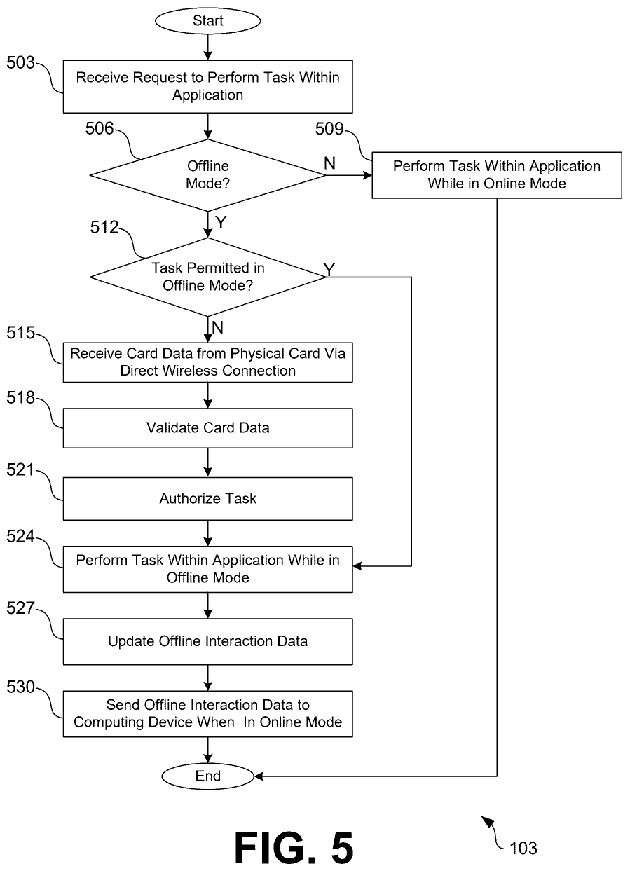

Referring next to FIG. 5, shown is a flowchart that provides one example of the operation of a portion of the client application 103. The flowchart of FIG. 5 provides merely an example of the many different types of functional arrangements that can be employed to implement the operation of the depicted portion of the client application 103. As an alternative, the flowchart of FIG. 5 can be viewed as depicting an example of elements of a method implemented within the offline task environment 200 and the network environment 300.

Beginning with block 503, the client application 103 can receive a request to perform a task within the client application 103. For example, a user interacting with a user interface 224 of the client application 103 can select a selectable component associated with a given task. The task can include initiating a transaction, gaining access to a location, verifying an identity, modifying one or more configurations within the issuer application, modifying user account data, and/or other types of tasks.

At block 506, the client application 103 can determine whether the client application 103 and/or the client device 106 are operating in an offline mode. For example, the client device 106 and the client application 103 operate in an offline mode when there is a lack of a network connection via the network 303. In this case, the client application 103 is unable to interact with the issuer service 227 over the network 303 and therefore, unable to receive the backend support provided by the issuer service 227. If the client application 103 and/or the client device 106 are operating in an online mode and therefore can interact with the issuer service 227, the client application proceeds to block 509. Otherwise, the client application 103 proceeds to block 512.

At block 509, the client application 103 can interact with the issuer service 227 to perform the requested task. In various examples, the issuer service 227 can generate and send an authentication token 109 to the client application 103 to permit the client application 103 to perform the requested task. Thereafter, this process proceeds to completion.

At block 512, the client application 103 can determine whether the requested task is permitted to be performed in offline mode. A user may request to perform an action within the client application 103 that does not require authentication or backend support from the issuer service 227. In this situation, the client application 103 can proceed to block 524. Otherwise, the client application 103 proceeds to block 515.

At block 515, the client application 103 can receive card data 121 from a payment card 112 that is associated with the payment account of the client application 103. For example, a user of a payment card 112 can tap or otherwise position the payment card 112 in an appropriate proximity to the communication device 251 of the client device 106 to establish a direct wireless connection 115. Upon establishing a direct wireless connection 115, the client application 103 can receive the card data 121 from the payment application 203 of the payment card 112.

In various examples, the card data 121 can include payment data 124, digital ID data 127, one or more authentication keys 130, and/or other data. In some examples, the card data 121 can include an authentication token 109. In some examples, the payment data 112 can include a cryptogram that is generated by the integrated circuit 118 of the payment card 112. The cryptogram can be generated by the payment card 112 using a card cryptographic key 212 stored on the payment card 112.

At block 518, the client application 103 can validate the card data 121. In various examples, the client application 103 can generate another cryptogram using the user data 234 stored in the client device store 233 and the device cryptographic key 230. Since the device cryptographic key 230 and the card cryptographic key 212 are derived from the same master key 229 and the user data 234 and payment data 124 should match by being associated with the same payment account, the cryptogram included in the payment data 124 received from the payment card 112 and the cryptogram generated by the client application 103 should match. The client application 103 can validate the card data 121 by comparing the cryptograms to determine a match. When the cryptograms match, the client application 103 can validate the card data 121.

In some examples, the card data 121 can include a digital signature that is signed the card cryptographic key 212 and/or other key. For example, the payment data 124 can include a digital signature. In this example, the client application 103 can validate the card data 121 by verifying the digital signature.

In some examples, the client application 103 can verify the authenticity of the payment card 112 providing the card data 121. For example, the digital ID data 127 can include an electronic a digital certificate, a verifiable credential, a trust anchor, a proof of trust, and/or other type of data that can be used to verify the authenticity of the payment card 112. In various examples, the digital ID data 127 can be issued by a trusted certificate authority to uniquely identify the issuer of the payment card 112. The client application 103 can verify the authenticity of the payment card 112 based at least in part on using a public key associated with the trusted entity issuing the digital ID data 127.

At block 521, the client application 103 can authorize the performance of the task. In some examples, the client application 103 can generate an authentication token 109 in response to validating the card data 121. The authentication token 109 can include a token that can be used to represent authorization of a user or user account associated with the client application 103 to perform a particular task. In some examples, the authentication token 109 can be generated to have a time-limit. Once the time-limit has expired, the authentication token 109 can no longer be used to prove current authentication status of the user account. In some examples, the time-limit and other restrictions associated with the authentication token 109 are defined in authentication keys 130 included in the card data 121.

In other examples, the authentication token can be generated by the payment card 112 and included in the card data 121. In this example, the client application 103 can verify the authentication token 109 when validating the card data 121 to ensure authenticity prior to presenting or otherwise using the authentication token 109 for the completion of a task.

At block 524, the client application 103 can perform the task while in the offline mode. The tasks can include initiating a purchase of an item, gaining access to a location, verifying an identity, modifying one or more configurations within the issuer application, updating user data and/or other types of tasks. For example, when a user is wanting to access a given location or initiate a payment, the user can tap or otherwise place the client device 106 and/or communication device 251 of the client device 106 in an appropriate proximity to the terminal 133 to establish an offline direct wireless connection 115 with the terminal 133. Upon establishing a direct wireless connection 115, the client device 106 can transmit an authentication token 109 and other relevant data (e.g., payment data 124) to the terminal 133 providing a task associated service. In the example of an access terminal 133, the client application 103 via the communication device 251 can transmit the generated authentication token 109 to the terminal 133 which can then be used to permit the user associated with the client device 106 access into a given location. Similarly, in the example of a payment terminal 133, the client application 103 can initiate a transaction and generate transaction data with the authentication token 109 and transmit the transaction data and authentication token 109 to the terminal 133 to initiate a transaction.

If the task is to be performed within the client application 103, the client application 103 can use the authentication token 109 and/or the validation of the card data 121 to grant access to update user data 124, configuration data 148, and/or other data within the client application 103. For example, the user may want to update his or her billing address in the user data 124. In another example, the user may want to update how a view associated with a given user interface 224 or application screen. In some examples, the authentication token 109 is required. In other examples, the performance of the task can be done in response to validating the card data 121.

At block 527, the client application 103 can update the offline interaction data 245. The offline interaction data 245 can represent data that is collected by the client application 103 in association to tasks completed offline. For example, the client application 103 can track the operations that it performs in an offline mode and then log data associated with the operations in the offline interaction data 245. The offline interaction data 245 can include data related to generating authentication tokens 109, initiating and completing a transaction, and/or any other task that the client application 103 may perform while in offline mode.

In some examples, the client application 103 can secure the offline interaction data 245 by digitally signing each recorded offline operation and store the signed operation in the offline interaction data 245. In some examples, the recorded operations can be digitally signed by the client application 103 using the device cryptographic key 230 or other cryptographic key that can be used to verify the authenticity of the client application 103. In some examples, the client application 103 can register each performed offline operation as a verifiable credential (VC). As such, when the issuer service 227 receives the offline interaction data 245, the issuer service 227 can contact a distributed ledger or other type of trusted entity to verify each verifiable credential to verify that the operations have occurred.

At block 530, the client application 103 sends the offline interaction data 245 to the issuer service 227. When the client application 103 and/or the client device 106 reestablish a network connection with the issuer service 227 via the network 303, the client application 103 can send the offline interaction data 245 to the issuer service 227. In some examples, the client application 103 can transmit the data. In other example, the client application 103 can send a rest application programming interface (API) call to the issuer service 227 to notify the issuer service 227 of the updated data. In various examples, the issuer service 227 can verify the received data and update accordingly. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same client device 106 or computing device, or in multiple computing devices in the same computing environment 221.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1-7. (canceled)

8. A method, comprising:
receiving, via a client device associated with a user account, a request to perform a task via the client device;
determining, via the client device, that the client device has a lack of a network connection, a performance of the task requiring the network connection;
establishing, via the client device, a direct wireless connection between the client device and an integrated circuit included on a physical card associated with the user account in response to detecting the integrated circuit being in proximity to a communication device of the client device;
receiving, via the client device, card data from the physical card via the direct wireless connection, the card data being received to initiate an authorization of the performance of the task by the client device in an offline mode;
validating, via the client device, the card data;
authorizing, via the client device, the performance of the task while in the offline mode in response to validating the card data; and
performing, via the client device, the task in the offline mode.

9. The method of claim 8, wherein the card data comprises payment data and digital identifier (ID) data.

10. The method of claim 9, wherein validating the card data comprises validating a digital signature of the payment data.

11. The method of claim 8, further comprising generating an authentication token in response to validating the card data.

12. The method of claim 11, wherein performing the task comprises using the authentication token.

13. The method of claim 12, wherein performing the task comprises transferring the authentication token to an access terminal or a payment terminal.

14. The method of claim 8, further comprising:
updating offline interaction data based at least in part on the performance of the task; and
sending the offline interaction data to a computing device in response to determining that a client device is in an online mode.

15-20. (canceled)

21. A system, comprising:
a client device comprising a processor, a communication device, and a memory, the client device being associated with a user account; and
machine-readable instructions stored in the memory that, when executed by the processor, cause the client device to at least:
receive a request to perform a task via the client device;
determine that the client device has a lack of a network connection, a performance of the task requiring the network connection;
establish a direct wireless connection between the client device and an integrated circuit included on a physical card associated with the user account in response to detecting the integrated circuit being in proximity to the communication device of the client device;
receive card data from the physical card via the direct wireless connection, the card data being received to initiate an authorization of the performance of the task by the client device in an offline mode;
validate the card data;
authorize the performance of the task while in the offline mode in response to validating the card data; and
perform the task in the offline mode.

22. The system of claim 21, wherein the card data comprises payment data and digital identifier (ID) data.

23. The system of claim 22, wherein validating the card data comprises validating a digital signature of the payment data.

24. The system of claim 21, wherein the machine-readable instructions further cause the client device to at least generate an authentication token in response to validating the card data.

25. The system of claim 24, wherein performing the task comprises using the authentication token.

26. The system of claim 25, wherein performing the task comprises transferring the authentication token to an access terminal or a payment terminal.

27. The system of claim 21, wherein the machine-readable instructions further cause the client device to at least:
update offline interaction data based at least in part on the performance of the task; and
send the offline interaction data to a computing device in response to determining that a client device is in an online mode.

28. A non-transitory, computer-readable medium, comprising machine-readable instructions that, when executed by a processor of a client device associated with a user account, cause the client device to at least:
receive a request to perform a task via the client device;
determine that the client device has a lack of a network connection, a performance of the task requiring the network connection;
establish a direct wireless connection between the client device and an integrated circuit included on a physical card associated with the user account in response to detecting the integrated circuit being in proximity to a communication device of the client device;
receive card data from the physical card via the direct wireless connection, the card data being received to initiate an authorization of the performance of the task by the client device in an offline mode;
validate the card data;
authorize the performance of the task while in the offline mode in response to validating the card data; and
perform the task in the offline mode.

29. The non-transitory, computer-readable medium of claim 28, wherein the card data comprises payment data and digital identifier (ID) data.

30. The non-transitory, computer-readable medium of claim 29, wherein validating the card data comprises validating a digital signature of the payment data.

31. The non-transitory, computer-readable medium of claim 28, wherein the machine-readable instructions further cause the client device to at least: generate an authentication token in response to validating the card data.

32. The non-transitory, computer-readable medium of claim 31, wherein performing the task comprises transferring the authentication token to an access terminal or a payment terminal.

33. The non-transitory, computer-readable medium of claim 28, wherein the machine-readable instructions further cause the client device to at least:
update offline interaction data based at least in part on the performance of the task; and
send the offline interaction data to a computing device in response to determining that a client device is in an online mode.
